(19) United States
(12) Patent Application Publication
(10) Pub. No.: US 2019/0265147 A1
(43) Pub. Date: Aug. 29, 2019

(54) DIRT SENSOR

(71) Applicant: RENTOKIL INITIAL 1927 PLC, Blackwater (GB)

(72) Inventors: Matt GREEN, Horsham (GB); Savvas OTHON, Charlton Kings (GB); David CULSHAW, London (GB)

(21) Appl. No.: 16/405,890

(22) Filed: May 7, 2019

Related U.S. Application Data
(63) Continuation of application No. PCT/GB2017/053354, filed on Nov. 8, 2017.

(30) Foreign Application Priority Data
Nov. 8, 2016 (GB) 1618859.1

(51) Int. Cl. G01N 15/04; G01N 15/06

(52) U.S. Cl. CPC G01N 15/04; G01N 2015/0042; G01N 15/0656; G01N 15/0606

(57) ABSTRACT

A dirt sensor comprising a dirt collecting surface exposed to allow dirt from the environment to build-up on the dirt collecting surface, and a transducer located in relation to the dirt collecting surface and responsive to dirt thereon to provide an output of the sensor dependent on the amount of dirt built-up on the dirt collecting surface.

### CROSS-REFERENCE TO RELATED APPLICATIONS

This Application is a continuation of PCT International Application PCT/GB2017/053354, filed Nov. 8, 2017, which claims priority to United Kingdom (GB) Application No. 1618859.1, filed Nov. 8, 2016, the contents of both of which are incorporated herein by reference in their entirety.

### INTRODUCTION

The present invention relates to the field of environmental sensors. In most premises and other locations dirt and dust builds up and many of these places should be kept clean for reasons of hygiene, safety and pest control. Visual inspection by a trained technician is often needed to decide when cleaning needs to take place. In the case of hard to reach places such an inspection is onerous. Examples of such places are roof girders in food factories, or within kitchen ventilation systems. To make an inspection safety procedures may have to be carried out, for example those for working at height, involving, for example, provision of ladders or platforms, and the whole area below may even have to be closed while the inspection is carried out, which of course leads to further financial loss in terms of production or sales in addition to the considerable expense of the inspection itself.

No alternative to this inspection procedure has been proposed.

### BRIEF SUMMARY

According to the present invention there is provided a dirt sensor comprising: a dirt collecting surface exposed to allow dirt from the environment to build-up on the dirt collecting surface, and a transducer located in relation to the dirt collecting surface and responsive to dirt thereon to provide an output of the sensor dependent on the amount of dirt built-up on the dirt collecting surface.

The dirt sensor may comprise a sensor for measuring an environmental variable other than dirt build-up, which may be, for example, a temperature sensor, or a humidity sensor, or a light level sensor.

The transducer may be responsive to an electrical property of dirt. The transducer may be arranged to sense the dirt capacitively.

The transducer may comprise electrodes in proximity to the dirt collecting surface. The electrodes may be interdigitated. The transducer may comprise a protective layer between the electrodes and the dirt collecting surface. The protective layer may provide the dirt collecting surface. The electrodes may be formed on a circuit board and the protective layer may cover the electrodes. The sensor may comprise a housing containing the transducer and the protective layer may be formed by a wall of the housing. The protective layer may be a removable film covering the electrodes.

The dirt collecting sensor may comprise an electronic circuit connected to the transducer to provide the output of the sensor. The electronic circuit may be connected to the transducer to drive the transducer. The electronic circuit may be arranged to provide a communications link to a remote location and to transmit the output of the sensor thereto. The communications link may be a radio communications link.

The dirt collecting sensor may comprise a power supply. The power supply may comprise a battery. The power supply may comprise a solar cell.

The present invention also provides a method of measuring the build-up of dirt in a location, comprising the steps of: locating a dirt collecting surface in a location where it is exposed to allow dirt to collect on it, locating a transducer in relation to the dirt collecting surface to provide an output dependent on the amount of dirt built-up on the dirt collecting surface, allowing dirt to build up over time on the dirt collecting surface, reading the output of the transducer.

The transducer may be, in providing the said output, responsive to an electrical property of the dirt built up on the dirt collecting surface. The transducer may sense the dirt build-up capacitively.

The method may comprise transmitting a value produced by the reading to a remote location.

The method may comprise cleaning or replacing the dirt collecting surface from time to time. The method may comprise cleaning the environment around the sensor at the same time as cleaning or replacing the dirt collecting surface.

The method may comprise cleaning the environment around the sensor in response to the reading.

The cleaning the environment around the sensor may comprise: measuring and recording one or more environmental variables for the location of the sensor, and recording the dirt transducer readings, analyzing dirt transducer measurements against the measurements of the one or more environmental variables and determining a relationship between them, and using the relationship to predict build-up of dirt in the location, and cleaning the environment around the sensor in response to the prediction.

The one or more environmental variables measured and recorded may comprise temperature. The one or more environmental variables measured and recorded may comprise humidity. The one or more environmental variables measured and recorded may comprise light level.

The method may comprise a cleaner gaining access to the sensor or the environment around it to perform the cleaning with equipment for working at height.

### BRIEF DESCRIPTION OF THE DRAWINGS

Embodiments of the invention will now be described, with reference to the accompanying drawings, of which:

FIG. 1 is a perspective view of a first embodiment of the sensor of the invention located for use,

FIG. 2 is a cross-section through the sensor of FIG. 1,

FIG. 3 is an underside view of the circuit board of the sensor of FIG. 1,

FIGS. 4a, 4b, and 4c illustrate the operation of the sensor as dirt builds up,

FIG. 5 is a cross-section through a second embodiment of the sensor of the invention, and

FIG. 6 is a cross-section through a third embodiment of the sensor of the invention.

FIG. 7 depicts a table of experimental results using one embodiment of a sensor as described herein.

### DETAILED DESCRIPTION

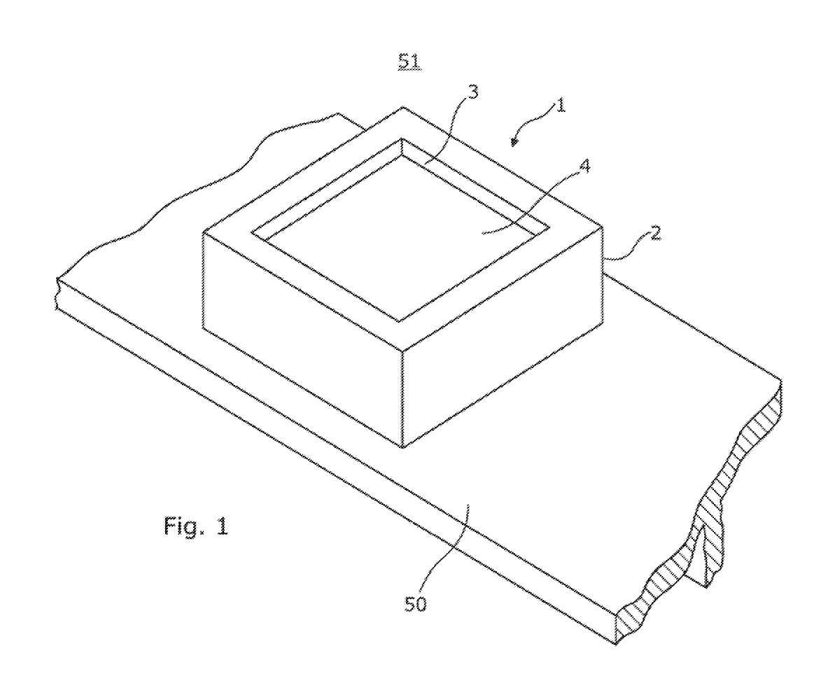

FIG. 1 is a perspective view of the sensor 1 of the invention, installed in an exemplary location. This has a housing 2 containing electronics and other components. The housing has window hole 3 exposing a sensing surface 4. In use the housing is mounted in the region to be sensed, for example, the housing is placed up on a roof girder 50 where the sensing surface collects dirt from the environment, in particular here the air 51, by the dirt settling on it or even condensing on to it. In this example the sensor has been placed with its sensing surface horizontal exposed to the air above it, but in other situations it may be appropriate to orient the sensing surface at an angle or even vertically, for example in situations where there is a significant air current, for example in an air duct.

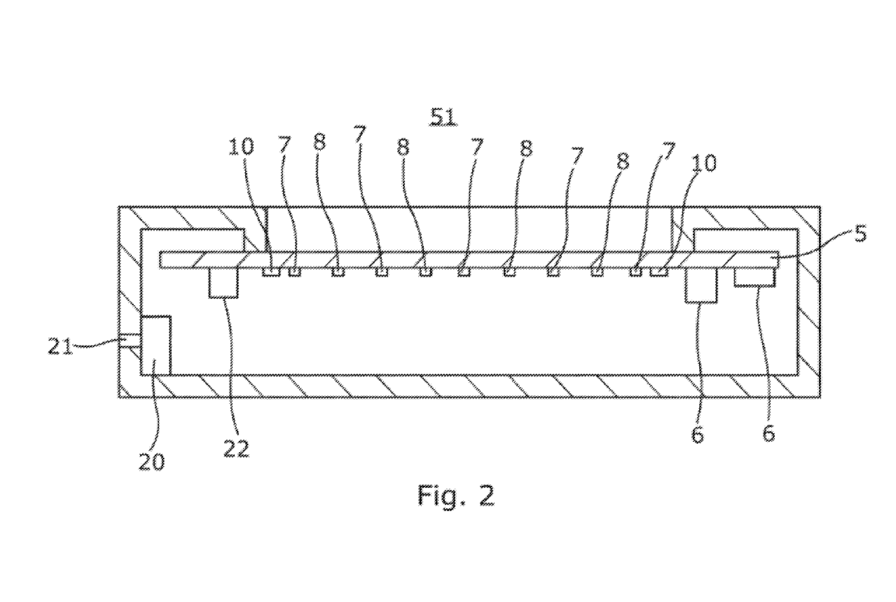

FIG. 2 shows a cross-section through the sensor 1. In this embodiment the sensing surface 4 is provided on a circuit board 5, which is mounted in the circuit board with the sensing surface exposed in the window 3. Sensing electronics 6 are mounted on the circuit board and take the measurements of the sensing surface and provide any drive signals necessary for that.

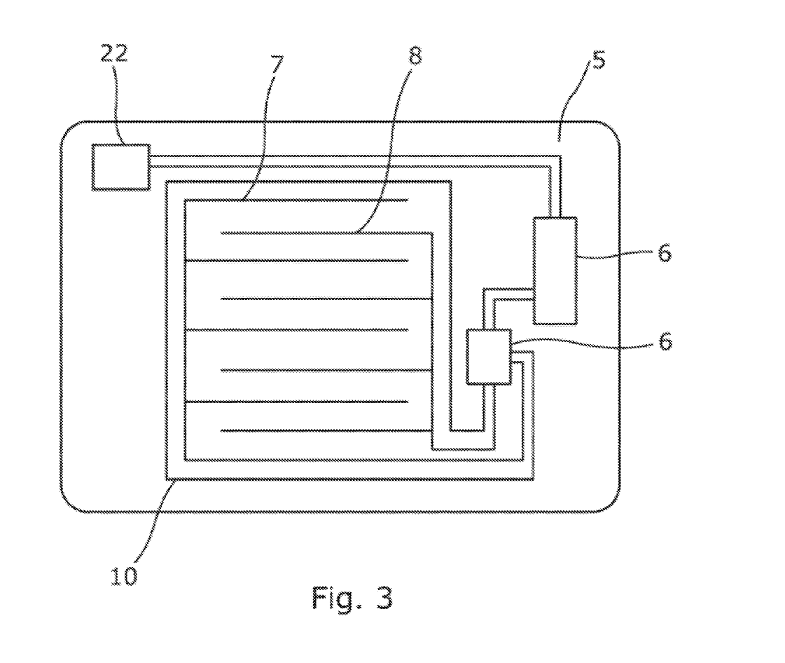

FIG. 3 shows the circuit board of the present embodiment from below. The circuit board is provided with a pair of interdigitated electrodes 7, 8 on the underside surface of the circuit board. These are, for protection, on the inside surface of the circuit board when mounted in the housing 2, and to avoid them being shorted by the dirt. The upper surface of the circuit board 5 provides the dirt collecting surface. The electrodes are provided by circuit traces on the circuit board, made in the usual way. Also provided is a guard ring electrode 10 running around the outside of the area of the two interdigitated electrodes. The electrodes 7, 8, 10 are connected to the sensing electronics 6, by further sections of circuit traces.

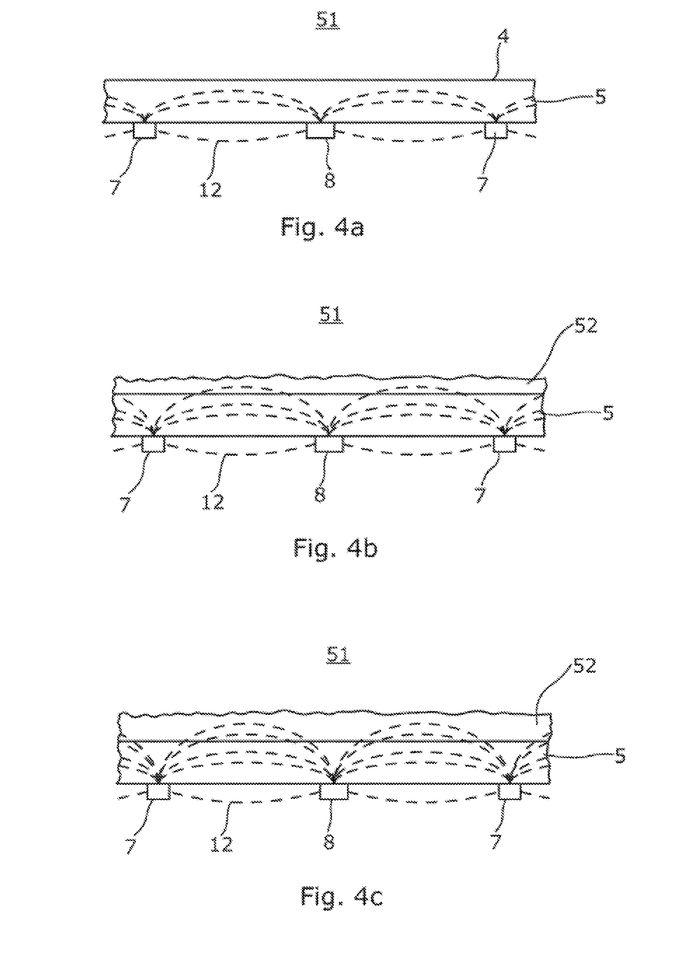

The interdigitated electrodes 7, 8 form a capacitor. FIG. 4a shows a cross-section through the circuit board showing the electric field 12 between the electrodes 7, 8 when the capacitor is charged (by a drive signal from the sensing electronics) in the case where there is no build-up of dirt on the sensing surface 4. Circuit boards are generally made of a dielectric material of greater relative permittivity than the air 51 and, as can be seen in the Figure, there is a greater concentration of electric field lines in the circuit board material between the electrodes 7, 8 than there is in the air above. This gives the capacitor a first capacitance. After time dirt, or deposit, 52 builds up on the sensing surface 4, as is the case shown in FIG. 4b, which is otherwise the same cross-section through the circuit board as FIG. 4a, and the electrodes are charged to the same voltage. Here the electric field again has a concentration of electric field lines running between the electrodes through the circuit board 5, but now there is also a concentration of field lines running through the dirt 52 as well. This occurs because dirt, at least many kinds of dirt, has a greater relative permittivity than air. The result is that the capacitor formed by the interdigitated electrodes 7, 8, has a greater capacitance than it does when there is no dirt on the sensing surface 4.

FIG. 4c shows a case where further dirt has built-up compared to FIG. 4b. Here the dirt 52 is thicker compared to FIG. 4b and, with the electrodes charged to the same voltage as before, there are additional field lines in the extra thickness of the dirt 52, so the capacitor formed by the interdigitated electrodes 7, 8, has an even greater capacitance than in the case of FIG. 4b.

(Note that it is not necessary for the circuit board material to have a greater permittivity than air, although it generally does. Even if the circuit board had a low relative permittivity, the build-up of dirt would cause an increase of electric field lines passing through the dirt and hence an increase in capacitance.)

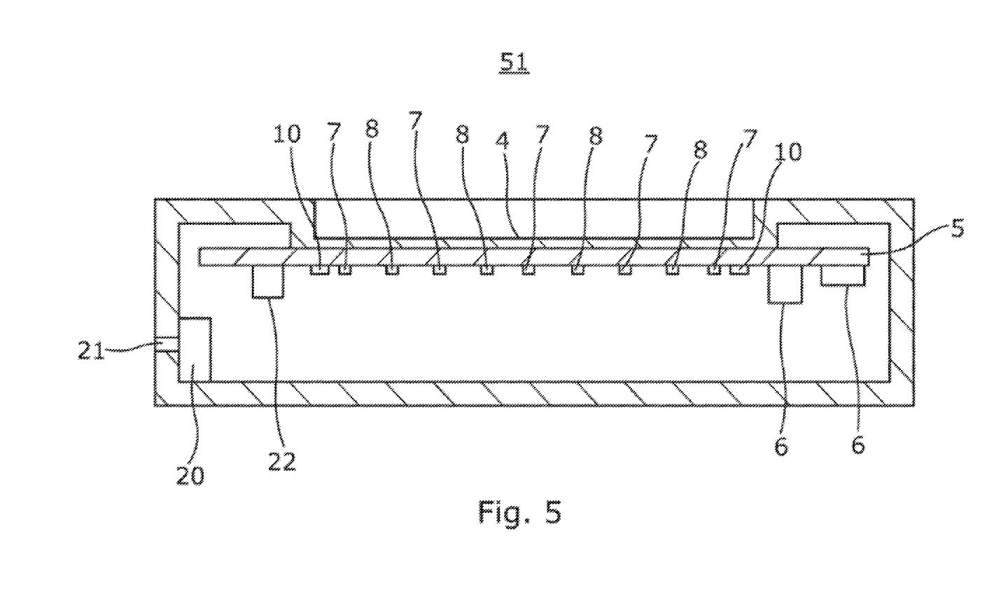

FIG. 5 shows a second embodiment, in cross-section through the housing. This is as the first embodiment except that the window is not a hole but is a section of the housing wall. The upper surface of this provides the dirt collecting surface 4. This section of the housing wall is made thinner than other walls of the housing because it provides a dielectric for the capacitor, providing more capacitance between the electrodes than the air at that position in the first embodiment, and so its thickness will reduce the fractional change in capacitance, compared to in the first embodiment, caused by a build-up of dirt of the same kind and thickness. In this case the window serves to provide protection to the circuit board. (That is particularly useful if the circuit board 4 has traces on its upper surface.) After a time in service the sensor is cleaned, as its sensitivity to extra dirt declines as the thickness of dirt increases.

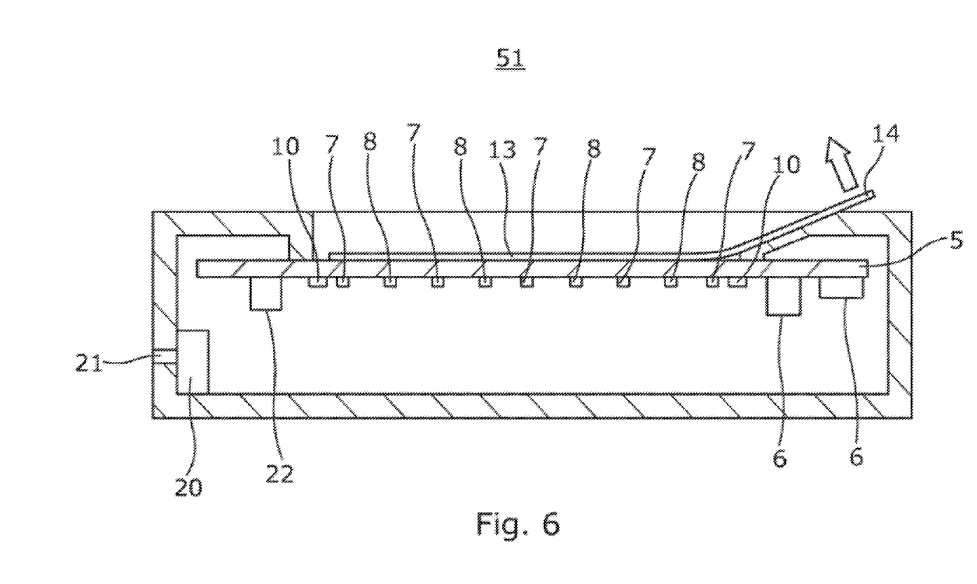

FIG. 6 shows a third embodiment, in cross-section through the housing. Again this is as the first embodiment but is provided with a removable film 13 over the sensing surface 4. The upper surface of this film 13 provides the dirt collecting surface. When the dirt build-up needs to be removed from the sensing surface the film is removed, taking the dirt with it. A replacement fresh clean film 13 is then put in place over the sensing surface 4. A tab 14 attached to the film is provided to help with manual removal of the surface. In other embodiments, several layers of film are provided over the sensing surface, with the top one being removed each time the sensor is to be cleaned. In this case the sensor electronics allows for the different thickness of dielectric provided by the films each time one is removed.

In each of the embodiments above the sensor is provided with a source of electrical power. While, for example, the sensor could be designed to work from mains power (or from that via a transformer), the difficult locations for the sensor will often not have mains power available so the sensor is provided preferably with a battery. This may be replaceable and/or rechargeable. Other power supplies such as a solar cell may be provided.

In each of the embodiments the sensor is provided with a data link for transmitting the data from the sensor to a remote location. This may be for example, a wireless data link, for example, radio, infra-red or even visible, or a wired link, for example a LAN cable. Transmitter and receiver circuitry for the communications link is, in these embodiments, included on the circuit board 5.

In electronics many different circuits are known for measuring capacitance, so the measuring circuit is not described in detail here. However many for example, employ a reference capacitor to deal with drift in the sensor output and one is used in the electronic circuit of the embodiments described above.

The guard ring 10, in these embodiments, is driven to a constant potential to avoid electrical signals near the sensor from interfering with the capacitor.

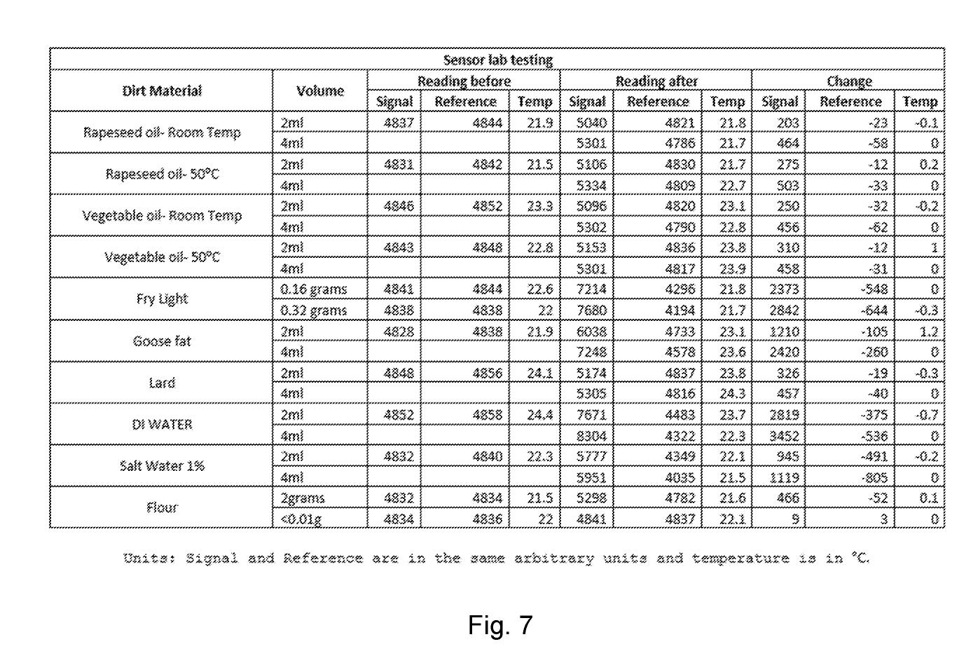

FIG. 7 depicts a table of experimental results gained with a prototype sensor according to the invention.

The “reference” in the table in FIG. 7 is the capacitance of the reference capacitor of the circuit. The “signal” is the reading when connected to the sensing electrodes, with and without dirt material on the sensing surface.

The measurements were taken as follows. The sensing surface was cleaned and the sensor left to settle, which was generally at a point where “signal” and “reference” readings were close. A volume of a material, which would in use be deposited on the sensor as dirt, was then pipetted onto the surface of the sensor and the sensor was left for 30 seconds for reading to normalize before “reading after” was taken. The change was then calculated. This process was then repeated for each type of material. The change in the signal values show that the dirt material causes significant change in the capacitance and hence that the sensor can be used to measure dirt build-up.

Other materials that cause dirt build-up and which may be detected by the sensor are: animal fats; vegetable fats; vegetable oils; nut oils; seed oils; flour of all kinds; dust (e.g., skin particles); material fibers/dust (e.g. cotton dust); carbon build up from burnt materials; insect body parts; grease and build up from animals; hair; and wood dust (e.g., saw dust).

Some of these dirt materials can cause explosive atmospheres and the invention may be of use in helping monitor their build-up and hence likelihood of an explosion occurring.

Other electrical properties of the dirt may be used by the sensor to detect it. More generally the sensor may use other physical properties to detect it, for example, its thermal conductivity, or optical sensing, for example using reflectivity or color.

An embodiment of a method of operating the sensor will now be described. From time to time an operator takes note of the reading transmitted by the sensor. If this shows that the environment around the sensor needs cleaning, or indeed the sensor itself needs cleaning to be able to continue to provide reliable readings the operator arranges for that environment and/or the sensor to be cleaned. A cleaner then gains access to the environment and/or the sensor, using, if needed, proper equipment for working at height, for example a ladder. When cleaning the sensor the cleaner cleans the dirt collecting surface carefully to avoid damaging the electrodes, removes the film 13 if that is being used and replaces it, or a set of films, as necessary.

As shown in FIGS. 2, 3, 5 and 6 each of the dirt sensors is provided with sensors 20 and 22 in addition to the dirt sensor itself, mounted in the housing of the sensor. These are sensors for measuring environmental variables other than dirt build-up such as temperature, humidity, light level, and so on. These may affect the build-up of the dirt, for example, affecting its thickness as measured by the dirt sensor. The data these additional sensors produce is logged with that from the dirt sensor for later analysis, to determine, for example, which environmental variables and to what extent, affect the rate of dirt build-up. (The sensors 20, 22 are connected to the circuit of the circuit board so that they may send their data via the communications link.) Temperature and humidity can affect the amounts of dirt material that are emitted by factory processes and the transport of them to the location being monitored. Light level can be an indicator of activity in the factory—for example, if a night shift is introduced then it is likely that the dirt build up will increase.

Sensor 22 is shown mounted on the circuit board. Sensor 20 is one needing access to the environment through a hole 21 in the housing of the sensor, for example a light level sensor. In these embodiments sensor 20 is conveniently mounted on the housing to enable it to be located easily in alignment with the hole 21. Sensor 20 is then connected to the circuit of the circuit board by jumper wires (not shown). In other embodiments sensor 20 is mounted on the circuit board 5 and that is mounted so that sensor 20 lines up with its hole 21. In these embodiments the additional sensors are also connected to the communications link to send their data via that also.

Some physical variables, for example, light levels will not be the same in all directions from the dirt sensor housing. To allow for that the sensor housing may be provided with several sensors of the same type but each mounted to point in a different direction to sense the physical variable in those directions.

In one embodiment of a method using the sensor, the data from the additional sensors is analyzed against the dirt sensor data to look for relationships between them, which relationships are then used to predict the level of dirt build-up over a coming period. Action is then taken to clean the environment of the sensor, or not, based on the prediction, for example to clean at a particular time, for example, on a particular date.

What is claimed is:

1. A dirt sensor, comprising:
a dirt collecting surface exposed to allow dirt from an environment to build-up on the dirt collecting surface, and
a transducer located in relation to the dirt collecting surface and responsive to dirt thereon to provide an output of the dirt sensor dependent on an amount of dirt built-up on the dirt collecting surface.

2. The dirt sensor according to claim 1, comprising a temperature sensor.

3. The dirt sensor according to claim 1, comprising a humidity sensor.

4. The dirt sensor according to claim 1 comprising a light level sensor.

5. The dirt sensor according to claim 1, wherein the transducer is responsive to an electrical property of dirt.

6. The dirt sensor according to claim 5 wherein the transducer is arranged to sense the dirt capacitively.

7. The dirt sensor according to claim 1, wherein the transducer comprises electrodes in proximity to the dirt collecting surface.

8. The dirt sensor according to claim 7, wherein the electrodes are interdigitated.

9. The dirt sensor according to claim 7, wherein the transducer comprises a protective layer between the electrodes and the dirt collecting surface.

10. The dirt sensor according to claim 9, wherein the protective layer provides the dirt collecting surface.

11. The dirt sensor according to claim 9, wherein the electrodes are formed on a circuit board and the protective layer covers the electrodes.

12. The dirt sensor according to claim 9, wherein the dirt sensor comprises a housing containing the transducer and the protective layer is formed by a wall of the housing.

13. The dirt sensor according to claim 9, wherein the protective layer is a removable film covering the electrodes.

14. A method of measuring a build-up of dirt in a location, comprising the steps of:
locating a dirt collecting surface in a location where it is exposed to allow dirt to collect on it;
locating a transducer in relation to the dirt collecting surface to provide an output dependent on an amount of dirt built-up on the dirt collecting surface;
allowing dirt to build up over time on the dirt collecting surface; and
reading the output of the transducer.

15. The method according to claim 14, wherein the transducer is, in providing the said output, responsive to an electrical property of the amount of dirt built-up on the dirt collecting surface.

16. The method according to claim 15, wherein the transducer senses the amount of dirt built-up capacitively.

17. The method according claim 14, comprising transmitting a value produced by the reading to a remote location.

18. The method according to claim 14, further comprising measuring and recording a temperature at the location.

19. The method according to claim 14, further comprising measuring and recording a humidity at the location.

20. The method according to claim 14, further comprising measuring and recording a light level at the location.
